(19) United States
(12) Patent Application Publication
(10) Pub. No.: US 2025/0200477 A1
(43) Pub. Date: Jun. 19, 2025

(54) SYSTEM AND METHOD CONFIGURED TO PERFORM FORENSIC ANALYSIS OF ELECTRONIC DATA USING SCORING

(71) Applicant: Morgan Stanley Services Group Inc., New York, NY (US)

(72) Inventors: Kamran Vatan Abadi, Montreal (CA); Nathan Simpson, Hockley (GB); Nikhil Awasthi, Edison, NJ (US); Sarah Foley, Brooklyn, NY (US)

(73) Assignee: Morgan Stanley Services Group Inc., New York, NY (US)

(21) Appl. No.: 18/539,635

(22) Filed: Dec. 14, 2023

(51) Int. Cl. G06Q 10/0635

(52) U.S. Cl. CPC G06Q 10/0635

(57) ABSTRACT

A system and method perform forensic analysis of electronic data using scoring. The system comprises a processor, a memory, a metric collection module to collect a plurality of metrics of received data, an analysis module to generate a measure of surprise from the metrics and to generate a plurality of scores using the measure of surprise, a detection module to detect problematic data among the received data using the plurality of scores, and a remediation module configured to remediate the problematic data. A display displays the plurality of scores in a column-based visualization sorted using a predetermined visualization selection. The method implements the system.

### FIELD OF THE DISCLOSURE

The present disclosure relates generally to forensic analysis of data, and, more particularly, to a system and method configured to perform forensic analysis of electronic data using scoring.

### BACKGROUND OF THE DISCLOSURE

Some organizations engage in thousands or millions of data transactions and events, which are subject to review; for example, to ensure compliance with relevant policies, controls, and regulatory requirements. The reviewing process has historically been a lengthy manual task which requires hours of work over a limited reviewing timeline such as a daily schedule. In the reviewing process, data metrics for transactions and events are collected and reviewed. For example, in an organization such as a financial institution with such a large volume of electronic data transactions and events, such as electronic trades, the financial institution collects thousands of key risk indicators (KRI) and other metrics of various kinds, generated by different systems daily for compliance review to ensure all trades are based on policies, controls, and regulations. In one approach in the prior art, data is reviewed in spreadsheets with no systematic view on correlation across different metrics.

In addition, for problematic data involving anomalies, outliers, and errors involving financial trades, the problematic data must be addressed before finalization of the corresponding trades. Alerts can be generated when the problematic data are detected. However, such a voluminous review of trades performed on a daily basis can result in “Alarm Fatigue” experienced by human reviewers routinely pouring over such trades. Accordingly, automation of such reviewing of trades can be effective and address the problem of “Alarm Fatigue”.

In addition, such data transactions and events are often displayed to reviewers of data and associated metrics using row-based visualization. The reviewer can be a trader or financial manager in a financial organization, with the data transactions and events corresponding to electronic trades. Alternatively, the reviewer can be a manager or administrator in a medical facility such as a hospital, with the data transactions and events involving insurance processing and the number of hospitalizations in the hospital. FIG. 1 is an example illustration of a screenshot with a row-based visualization 100 of data according to the prior art, which can be displayed on a display or monitor of a computing device. After collecting data for a metric, the metric data can include the number of electronic trades conducted by the financial organization in electronic stock exchanges in three different cities, as well as the reporting city, indicated by name, data, and time. Alternatively, the metric data can include the number of hospitalizations involved in a medical facility due to traffic related injuries in three different cities, as well as the reporting city, indicated by name, date, and time. The row-based summarization and visualization 100 in the prior art shown in FIG. 1 is a straightforward aggregation method, with the summary of each city and time for every single date. Although the visualization 100 provides summary information of different columns for 104, 106 for each day 102, to keep the integrity of the row, it is necessary to break apart the values in the other columns 104, 106 for each day.

The displayed data of the row-based visualization 100 is output by a user interface (UI) on the display or monitor in which the data is arranged in rows 102 by date, and in columns 104, 106 by city and time, respectively. The user interface can be a graphic user interface (GUI) displaying the data in the row-based visualization 100. Alternatively, the user interface is an alphanumeric display. FIG. 2 is another example illustration of a screenshot of a row-based visualization 200 of data displayed on a user interface according to the prior art when there are only two columns 202, 204. In such a visualization 200, a wide scrolling horizontally and manually of the user interface through the data, as represented by the arrows 206, is necessary for a reviewer to review all of the data, even though the data is only arranged in just two columns 202, 204. Such manual scrolling is inconvenient and time-consuming. Accordingly, improved visualization of data through a user interface can facilitate efficient review of data, for example, for electronic trades.

### SUMMARY OF THE DISCLOSURE

According to an embodiment consistent with the present disclosure, a system and method are configured to perform forensic analysis of electronic data using scoring. In one implementation consistent with the invention, the system and method are configured to operate with and process any data such as electronic trades for a financial organization, electronic medical data for a medical organization, etc.

In an embodiment, a system comprises a hardware-based processor, a memory, and a set of modules. The memory is configured to store instructions and configured to provide the instructions to the hardware-based processor. The set of modules is configured to implement the instructions provided to the hardware-based processor. The set of modules includes a metric collection module, an analysis module, a detection module, and a remediation module. The metric collection module is configured to collect a plurality of metrics of received data. The analysis module is configured to generate a measure of surprise using a predetermined measuring algorithm applied to the metrics, and to generate a plurality of scores each associated with a corresponding metric using the measure of surprise. The detection module is configured to detect problematic data among the received data using the plurality of scores. The remediation module configured to remediate the problematic data.

The problematic data can be selected from the group consisting of: an anomaly, an outlier, and an error in the received data. The remediation module can be configured to perform a remediation action selected from the group consisting of: a roll back of the problematic data, deletion of the problematic data, or flagging the problematic data. The received data can include electronic financial trades. The analysis module can normalize the plurality of scores to be within a predetermined range of normalized values. The analysis module can aggregate the plurality of scores to generate an aggregated score. The system can further comprise a display configured to display the plurality of scores associated with the received data. The display can display the plurality of scores in a column-based visualization sorted using a predetermined visualization selection. The predetermined visualization selection can be selected from the group consisting of: sorting by dimension value, sorting by metric value, and sorting by date.

In another embodiment, a system comprises a display, a hardware-based processor, a memory, and a set of modules. The memory is configured to store instructions and configured to provide the instructions to the hardware-based processor. The set of modules is configured to implement the instructions provided to the hardware-based processor. The set of modules include a metric collection module and an analysis module. The metric collection module is configured to collect a plurality of metrics of received data. The analysis module is configured to generate a measure of surprise using a predetermined measuring algorithm applied to the metrics, and to generate a plurality of scores each associated with a corresponding metric using the measure of surprise. The display displays the plurality of scores in a plurality of columns using a predetermined column-based visualization configuration.

The system can further comprise a detection module configured to detect problematic data among the received data using the plurality of scores, and a remediation module configured to remediate the problematic data. The remediation module can be configured to perform a remediation action selected from the group consisting of: a roll back of the problematic data, deletion of the problematic data, or flagging the problematic data. The problematic data can be selected from the group consisting of: an anomaly, an outlier, and an error. The received data can include electronic financial trades. The analysis module can normalize the plurality of scores to be within a predetermined range of normalized values. The analysis module can aggregate the plurality of scores to generate an aggregated score. The display can display the plurality of scores in a column-based visualization sorted according to a predetermined visualization selection. The predetermined visualization selection can be selected from the group consisting of: sorting by dimension value, sorting by metric value, and sorting by date.

In a further embodiment, a method comprises collecting received data in a database, generating a plurality of metrics from the received data, collecting a plurality of metrics in the database, generating a plurality of measures of surprise using a predetermined measuring algorithm wherein each measure of surprise corresponds to a respective one the plurality of metrics, generating a micro-statistical model from the plurality of measures of surprise, generating a plurality of scores wherein each score corresponds to a respective one of the plurality of metrics using the micro-statistical model, outputting the plurality of scores wherein at least one score indicates problematic data, and remediating the problematic data. The outputting can include displaying the plurality of scores in a column-based visualization sorted according to a predetermined visualization selection.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a screenshot illustrating a row-based visualization according to the prior art.

FIG. 2 is another screenshot illustrating a row-based visualization according to the prior art.

FIG. 3 is a schematic of a system, according to an embodiment.

FIG. 4 is a schematic of portions of the system of FIG. 3 in greater detail.

FIG. 5 is a schematic of a computing device used in the embodiment of FIGS. 3-4.

FIG. 6 illustrates a flow of processing of metric data to perform scoring using the system of FIG. 3.

FIG. 7 is a screenshot of a graphic user interface configured to control settings of operating parameters of the system of FIG. 3.

FIG. 8 is a screenshot illustrating a column-based visualization with data sorted by dimension using the system of FIG. 3.

FIG. 9 is another screenshot illustrating of column-based visualization with data sorted by metrics values using the system of FIG. 3.

FIG. 10 is a further screenshot illustrating a column-based visualization with a fixed width per column.

FIG. 11 is a flowchart of a method of remediation using the system of FIG. 3.

FIG. 12 is a flowchart of a method of visualization using the system of FIG. 3.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 300 and method configured to perform forensic analysis of electronic data using scoring.

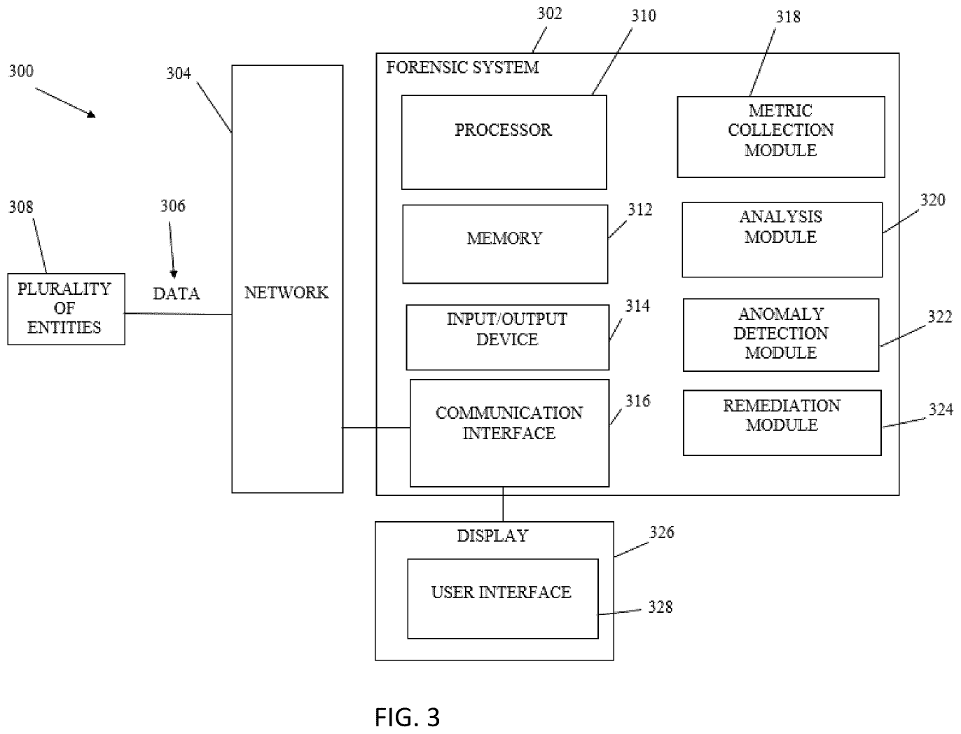

As shown in FIG. 3, the system 300 includes a forensic system 302 operatively connected to a network 304 to receive data 306 from a plurality of entities 308. In one implementation consistent with the invention, the system 300 is employed by a financial organization, and so the data 306 is trades data from the plurality of entities 308 in the financial organization. In another implementation, the data 306 is medical data from a plurality of entities 308 of a medical facility such as a hospital. In a further implementation, the data 306 is any organization-based data from a plurality of entities 308 of an organization. The network 304 is an internal network of an organization, such as an intranet connecting multiple computing devices of users as the entities 308 to the forensic system 302. Alternatively, the network 304 is the Internet. In another implementation consistent with the invention, the network 304 is any known type of network.

In an implementation, each entity 308 is a financial trader or a group of traders generating or operating with the data 306 as trades data. Alternatively, the entities 308 include financial managers, brokers, or any person or organization operating to engage in financial transactions such as trades. In another implementation, each entity 308 is an employee of a medical facility such as a hospital, with the entities 308 being doctors, nurses, or equipment technicians generating or operating with medical data in the medical facility. In a further implementation, each entity 308 is associated with a user generating or operating with organization-based data. The computing device of each entity 308 includes a trading desk in the form of a workstation. Alternatively, the computing device of each entity 308 includes a personal computer, a laptop, a tablet, a smartphone, or any known computing device configured to process data for financial transactions such as the data 306.

The forensic system 302 includes a processor 310, a memory 312, an input/output device 314, a communication interface 316, a metric collection module 318, an analysis module 320, an anomaly detection module 322, and a remediation module 324. The processor 310 is hardware-based. The memory 312 is configured to store instructions and configured to provide the instructions to the hardware-based processor 310. The input/output device 314 is a device configured to receive inputs from a user, such as a system administrator or a financial manager. In addition, the input/output device 314 is a device configured to output information to the user. The input/output device 314 includes a keyboard, keypad, mouse, or any known input mechanism. The input/output device 314 includes a display or monitor configured to display a user interface, such as a GUI. Alternatively, the user interface of the input/output device 314 includes an alphanumeric display. In other implementations, the user interface of the input/output device 314 is any known input device or output device to receive or convey information, respectively, from or to a user, respectively.

The communication interface 316 is configured to operatively connect the forensic system 302 to the network 304 to receive the data 306 to the processor 310 or the memory 312. Through the communication interface 316, the forensic system 302 collects the data 306 from the plurality of entities 308. The term “collect” includes In one implementation consistent with the invention, the forensic system 302 or a component of the forensic system 302, such as the processor 310, collects the data 306 by receiving the data 306 transmitted from the plurality of entities 308. For example, the plurality of entities 308 is configured to transmit the data 306 at a scheduled time, such as daily. In another implementation, the forensic system 302 or a component of the forensic system 302, such as the processor 310, collects the data 306 by polling plurality of entities 308 to transmit the data 306. For example, the forensic system 302 or a component of the forensic system 302, such as the processor 310, is configured to poll the plurality of entities 308 to transmit the data 306 at a scheduled time, such as daily.

In one implementation, the scheduled transmitting time of data 306 or scheduled polling time of the plurality of entities 308 is set to be daily by default. In a further implementation, a system administrator or a financial manager uses the input/output device 314 to enter inputs configured to set the scheduled transmitting time or polling time. The communication interface 316 is also configured to operatively connect the forensic system 302 to a display 326 configured to display a user interface 328. The display 326 and the user interface 328 are configured to display the data 306 generated by the plurality of entities 308 as well as other data such as scores generated by the forensic system 302. Such data 306 or other data are displayed to a reviewer, as described in greater detail below.

The metric collection module 318, the analysis module 320, the anomaly detection module 322, and the remediation module 324 are a set of modules configured to implement the instructions provided to the hardware-based processor 310. The metric collection module 318 is configured to generate or collect metric data corresponding to the data 306. In one implementation, the metric collection module 318 includes a metric generation module configured to generate the metric data from the data 306 using a predetermined metric data generation method. The predetermined metric data generation method includes any known equations or algorithms configured to generate metric data from the data 306, as described below. In an alternative implementation, the processor 310 includes the metric generation module configured to generate the metric data from the data 306 using the predetermined metric data generation method. The metric collection module 318 then receives the generated metric data from the processor 310. In a further alternative implementation, the forensic system 302 includes the metric generation module separate from the metric collection module 318 and configured to generate the metric data from the data 306 using the predetermined metric data generation method. The metric collection module 318 then receives the generated metric data from the separate metric generation module. In another alternative implementation, an external source of metric data generates the metric data from the data 306, and sends the metric data to the metric collection module 318 through the network 304.

In one implementation, the metric collection module 318 collects the generated metric data by storing the metric data in the memory 312. Alternatively, the metric collection module 318 collects the metric data by storing the metric data in a central storage 410, as described below. The central storage 410 is implemented as a database in the memory 312. Alternatively, the central storage 410 is implemented as a database in the forensic system 302 separate from the memory 312. In an alternative implementation, the metric collection module 318 collects the metric data by receiving the metric data generated by a metric generation module included in the processor 310 or in the overall forensic system 302. In another alternative implementation the metric collection module 318 collects the metric data by receiving the metric data from an external source of metric data.

In an implementation, the metric data includes a key risk indicator (KRI). In another implementation, the metric data includes a key performance indicator (KPI). In any given implementation, a variety of metric data can be collected as is pertinent to the business activity of the enterprise using the system. The analysis module 320 is configured to analyze such metric data, trades data, or other data. The anomaly detection module 322 is configured to process the metric data to detect and identify problematic data involving anomalies, outliers, and errors. Such problematic data are highlighted by a reviewer such as a trader, by the trading desk, or by region. The characterization or classification of data as being problematic is based on the behavior of individuals or groups generating the data. For example, such individuals or groups are individual financial traders and group behavior of financial traders and can be formalized in rules that are maintained in the memory 312 and processed by the anomaly detection module 322. In one implementation, the anomaly detection module 322 generates and outputs alerts, notifications, or messages to a reviewer through the user interface 328 of the display 326. For example, the alerts, notifications, or messages are displayed visually by text messages or graphical representations such as color-coded symbols displayed through the user interface 328. In another example, the alerts, notifications, or messages are audibly output through the user interface 328. In a further example, the display 326 includes an audio speaker configured to generate sounds corresponding to the alerts, notifications, or messages. In another implementation, the anomaly detection module 322 generates and outputs alerts, notifications, or messages to a reviewer through the input/output device 314 including a display, a speaker, or a user interface.

For example, in a financial organization, the problematic data can include an unauthorized trade, fictious orders, front running of trades, insider trading, etc., all coded by rules that compare trades to other data. The remediation module 324 is configured to implement a remediation action to correct for such detected anomalies, outliers, and errors in the data 306. For example, as described below, a displayed aggregate daily score associated with a respective electronic trade is viewed by a reviewer using the user interface 328 on the display 326. The user interface 328 is provided with controls such as actuatable icons on the user interface 328. In such a review, if the aggregate daily score represents problematic data representing a problematic financial trade or transaction associated with a trader, such as an anomaly, an outlier, or an error in trades, the reviewer uses the controls of the user interface 328 to remediate the problematic data, such as the problematic financial trade or transaction. For example, a reviewer performs a remediation action, such as a roll back of the problematic trade, deletion of the problematic trade, or flagging the problematic trade using the user interface 328. In certain implementations, the reviewer is an artificial intelligence-based subsystem that automates at least the initial review to flag trades perceived as being problematic.

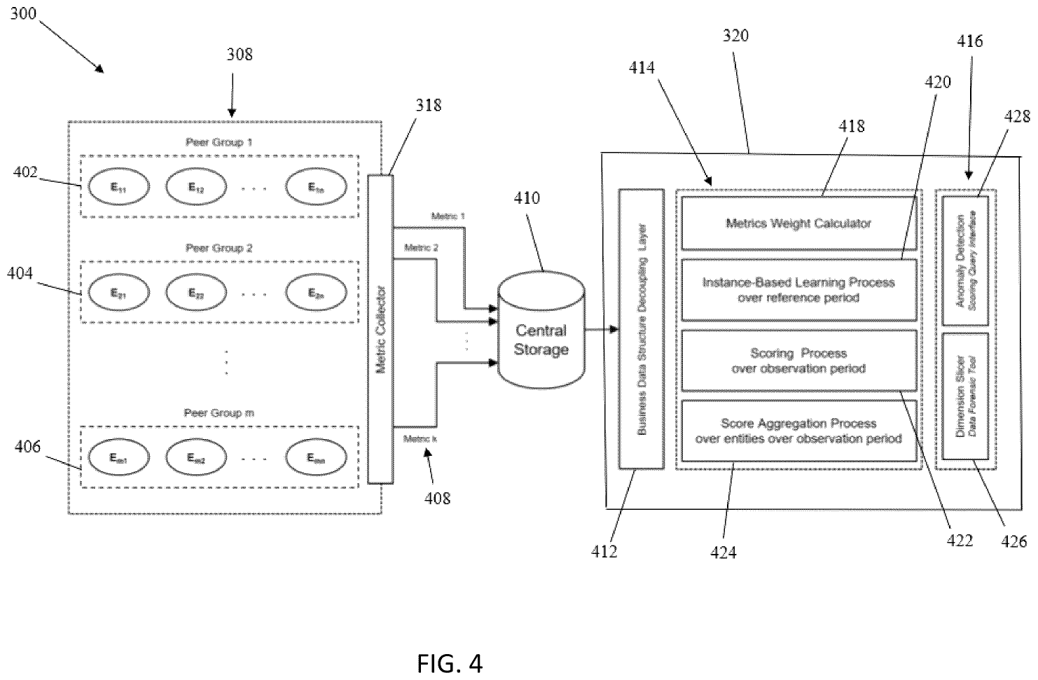

FIG. 4 is a schematic of portions of the system 300 of FIG. 3 in greater detail. In an implementation, the plurality of entities 308 are grouped into peer groups 402, 404, 406, such as m number of groups. In one implementation, each peer group 402, 404, 406 has n number of entities. For example, the peer group 402, labelled Peer Group 1, includes entities E₁₁, E₁₂, . . . . E₁ₙ. In an alternative implementation, each peer group 402, 404, 406 has a different number of entities per peer group. A system administrator, using the input/output device 314, can set up and populate the peer groups 402, 404, 406. For example, one peer group can include all of the people who are in a same country, or all of the people who are in the same country and city, as well as have the same salary range, or even people who have the same job title. Such settings defining the peer groups 402, 404, 406 is stored as in a peer group configuration file in the memory 312. The peer group configuration file can have a JavaScript Object Notation (JSON) file format, or any other known file format.

Each peer group 402, 404, 406 generates corresponding metrics 408, such as Metric 1, Metric 2, . . . . Metric k, which are collected by the metric collection module 318 as a metric collector. The metrics 408 are measurements of shared and unshared attributes associated with the data 306 using predetermined metric equations or algorithms. For example, an example metric can be set to the value one as an initial or default metric scoring. Another example metric can be the ratio of a financial amount of a trade over the quantity of the trade, such as (U.S. dollar amount)/quantity. A further example metric can be the ratio of a trade adjustment value over a market value of the trade, or adjustment/(market value). The metric can be associated with a date or time. For example, each calculated metric can be timestamped. The metric data corresponding to each metric is generated and collected as described above.

Each of the metrics 408 is stored in a central storage 410. In one implementation, the central storage 410 is included in the memory 312. Alternatively, the central storage 410 is included in the forensic system 302 separate from the memory 312. The memory 312 also stores configuration data in configuration files specifying metrics information such as data sources, tables, and columns mapping information to configure and display visualizations of data, as described below. The configuration files can have a JSON file format, or any other known file format. In an implementation, the central storage 410 is a database. For example, the central storage 410 is implemented using a Structured Query Language (SQL) based database. Alternatively, the central storage 410 is implemented using any known database. The analysis module 320 is configured to process the metrics 408 from the central storage 410. In an example implementation, the analysis module 320 includes a business data structure decoupling (BDSD) layer 412, a plurality of modules 414, and a plurality of interfaces 416.

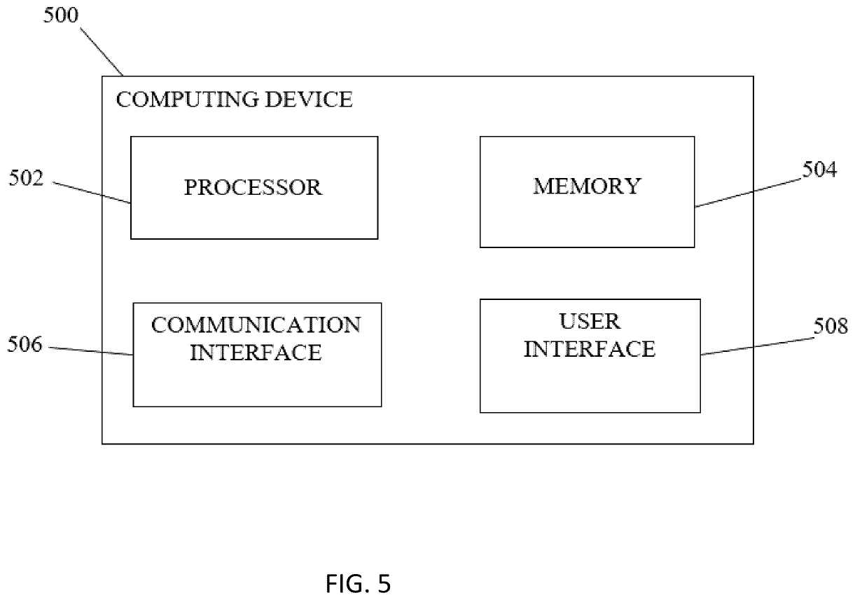

FIG. 5 illustrates a schematic of a computing device 500 implementing the system 300 and components shown in FIGS. 3-4. The computing device 500 includes a processor 502 having code therein, a memory 504, and a communication interface 506. Optionally, the computing device 500 can include a user interface 508, such as an input device, an output device, or an input/output device. The processor 502, the memory 504, the communication interface 506, and the user interface 508 are operatively connected to each other via any known connections, such as a system bus, a network, etc. Any component, combination of components, and modules of the system 300 in FIG. 3 can be implemented by a respective computing device 500. For example, each of the components shown in FIGS. 3-4 can be implemented by a respective computing device 500 shown in FIG. 5 and described below.

It is to be understood that the computing device 500 can include different components. Alternatively, the computing device 500 can include additional components. In another alternative implementation, some or all of the functions of a given component can instead be carried out by one or more different components. The computing device 500 can be implemented by a virtual computing device. Alternatively, the computing device 500 can be implemented by one or more computing resources in a cloud computing environment. Additionally, the computing device 500 can be implemented by a plurality of any known computing devices.

The processor 502 can be a hardware-based processor implementing a system, a sub-system, or a module. The processor 502 can include one or more general-purpose processors. Alternatively, the processor 502 can include one or more special-purpose processors. The processor 502 can be integrated in whole or in part with the memory 504, the communication interface 506, and the user interface 508. In another alternative implementation, the processor 502 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 502 can include a plurality of processing elements configured to perform parallel processing. In a further alternative implementation, the processor 502 can include a plurality of nodes or artificial neurons configured as an artificial neural network. The processor 502 can be configured to implement any known artificial neural network, including a convolutional neural network (CNN).

The memory 504 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 502 can be stored in a memory internal to the processor 502. The code can be instructions implemented in hardware. Alternatively, the code can be instructions implemented in software. The instructions can be machine-language instructions executable by the processor 502 to cause the computing device 500 to perform the functions of the computing device 500 described herein. Alternatively, the instructions can include script instructions executable by a script interpreter configured to cause the processor 502 and computing device 500 to execute the instructions specified in the script instructions. In another alternative implementation, the instructions are executable by the processor 502 to cause the computing device 500 to execute an artificial neural network. The processor 502 can be implemented using hardware or software, such as the code. The processor 502 can implement a system, a sub-system, or a module, as described herein.

The memory 504 can store data in any known format, such as databases, data structures, data lakes, or network parameters of a neural network. The data can be stored in a table, a flat file, data in a filesystem, a heap file, a B+ tree, a hash table, or a hash bucket. The memory 504 can be implemented by any known memory, including random access memory (RAM), cache memory, register memory, or any other known memory device configured to store instructions or data for rapid access by the processor 502, including storage of instructions during execution.

The communication interface 506 can be any known device configured to perform the communication interface functions of the computing device 500 described herein. The communication interface 506 can implement wired communication between the computing device 500 and another entity. Alternatively, the communication interface 506 can implement wireless communication between the computing device 500 and another entity. The communication interface 506 can be implemented by an Ethernet, Wi-Fi, Bluetooth, or USB interface. The communication interface 506 can transmit and receive data over a network and to other devices using any known communication link or communication protocol.

The user interface 508 can be any known device configured to perform user input and output functions. The user interface 508 can be configured to receive an input from a user. Alternatively, the user interface 508 can be configured to output information to the user. The user interface 508 can be a computer monitor, a television, a loudspeaker, a computer speaker, or any other known device operatively connected to the computing device 500 and configured to output information to the user. A user input can be received through the user interface 508 implementing a keyboard, a mouse, or any other known device operatively connected to the computing device 500 to input information from the user. Alternatively, the user interface 508 can be implemented by any known touchscreen. The computing device 500 can include a server, a personal computer, a laptop, a smartphone, or a tablet.

Referring back to FIG. 4, in the analysis module 320, the BDSD layer 412 is a module configured is to provide sufficient knowledge about metrics and business expectation so that the forensic system 302 can handle the processing of data including the metrics 408, the data 306, or other data from the entities 308. The BDSD layer 412 operates as an intermediary module configured to control the processing of data from the different peer groups 402, 404, 406. For example, in an organization such as a hospital, the metrics 408 of patients are differentiated and processed by their groups, such “emergency”, “surgery”, “cancer”, “neurology”, etc. In another example, in a financial institution, the metrics 408 of traders in groups are differentiated and processed by different trading desks. There is no limit to defining and delincating peer groups. For the example of a financial institution, the trading desks are arranged in different cities or geographical locations to cover traders who do not work with a single desk in a single location.

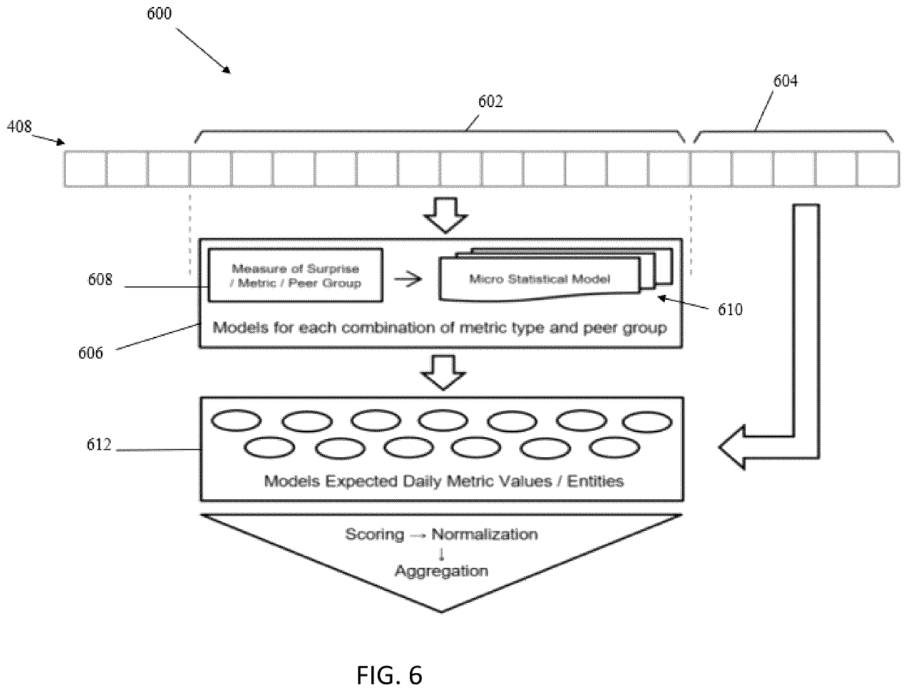

The plurality of modules 414 includes a metrics weight calculator 418, an instance-based learning process (IBLP) 420 operating over a reference period 602 as shown in FIG. 6, a scoring process 422 operating over an observation period 604 as shown in FIG. 6, and a score aggregation process 424 operating over entities over the observation period 604. The reference period is a time interval over which a model is built, and the observation period is a time interval in which the model is evaluated to determine whether the model fits the reference period. In one implementation, the reference period spans three months and the observation period spans seven data. For example, the reference period 602 is the time interval from 2023 Jul. 4 to 2023 Oct. 3, and the observation period 604 is the time interval from 2023 Oct. 4 to 2023 Oct. 10. In another example, the instance-based learning process 420 operates to observe the model for a single, such that the reference period 602 is the time interval from 2023 Jul. 4 to 2023 Oct. 3, and the observation period is the time interval form 2023 Oct. 4 to 2023 Oct. 4. In a further example, the instance-based learning process 420 is configured to compare a single month in the year 2022 and in the year 2023, such that the reference period 602 is the time interval from 2022 Oct. 1 to 2022 Oct. 31, and the observation period 604 is the time interval from 2023 Oct. 1 to 2023 Oct. 31.

Referring to FIG. 6, the metrics weight calculator 418 is configured to operate using the two main time intervals: the reference period 602 and the observation period 604. The reference period 602 is a time interval for establishing an expectation or model, and the observation period 604 is the time interval in which the models are observed to see how much a given model satisfies expectations. The metrics weight calculator 418 generates a measure of surprise (MOS) for every single metric and for every peer group. The measure of surprise measures how much an observed metric, alert, event, or KRI surprises a user, such as a reviewer, upon receiving the observed value. The measure of surprise is a change in entropy of a metric in each peer group 402, 404, 406 from the reference period 602 to the observation period 604.

During the reference period 602, the instance-based learning process 420 applies machine learning to process the metrics 408 for a specific timeframe, such as the daily metrics, according to models 606 for each combination of metric types and peer group. In such models 606, the measure of surprise 608 generated by the metrics weight calculator 418 is determined using a predetermined measuring algorithm for each metric and each peer group. For example, the metrics weight calculator 418 determines a variable MetricShareInReferencePeriod for a given metric Mi which is determined by MetricShareInReferencePeriod (M)=(count of the metrics Mj=Mi occurring during the reference period)/(count of the metrics Mj occurring during the reference period and also belonging to available measures).

The metrics weight calculator 418 also determines another variable ΔH, which is a change of metric entropy of a metric Mi with reference to an attribute A. The value of ΔH determined to be equal to the absolute value of (the metric entropy of Mi during the reference period minus the metric entropy of Mi during the observation period). The change of metric entropy ΔH indicates how much that the behavior of peer groups has changed over a selected attribute A.

The metric entropy of Mi with reference to an attribute A (MetricEntropy (Mi, A) is determined by the metrics weight calculator 418:

$$MetricEntropy ( Mi , A ) = - \sum ( mp ( {A}_{v} ) \times log ( mp ( {A}_{v} ) )$$

in which mp ( ) is a discrete probability density function of the metric Mi with reference to attribute A over a period from a start date (sd) to an end date (ed). In particular, the discrete probability density function mp ( ) is the probability P (attribute A of a measure i=v) from the start date (sd) to an end date (ed). The summation above is over the distinct attribute values v with Av being a specific attribute value.

The measure of surprise for a given metric Mi with reference to an attribute A is then determined by the metrics weight calculator 418 to be equal to:

$$MoS ( Mi , A ) = \frac{( 1 + \frac{1}{( 1 + {e}^{- k ( Δ H - 1 )} )} )}{MetricShareInReferencePeriod}$$

in which k is a scaling factor. The scaling factor k can be set by a system administrator using the input/output device 314. For example, the scaling factor k can be set to be the numeric value 6. Accordingly, metrics which generate less alarm or less events are more important to be reviewed as well as metrics having a metric entropy over a given attribute A which changes between the reference period and the observation period. The measure of surprise includes two factors: a first factor which identifies the importance of the metric Mi in general during the reference period, and a second factor which identifies the importance of the metric attributes A in each peer group.

In an implementation, the instance-based learning process 420 performs a machine learning algorithm. For example, the machine learning algorithm is a neural network having a plurality of nodes or artificial neurons configured in a plurality of layers. The neural network is trained using a predetermined training set of past measures of surprise for each metric and a set of past micro-statistical models. Once trained, the neural network processes new metrics from new data 306 to generate a new micro-statistical model. Alternatively, the machine learning algorithm is any known type of machine learning configured to generate a micro-statistical model from new metrics of new data 306. In one implementation, the instance-based learning process 420 uses an ensemble Gaussian model or an ensemble Gaussian processes model to build the micro-statistical models. Such an ensemble Gaussian processes model is a probabilistic supervised machine learning framework configured to perform regression or classification.

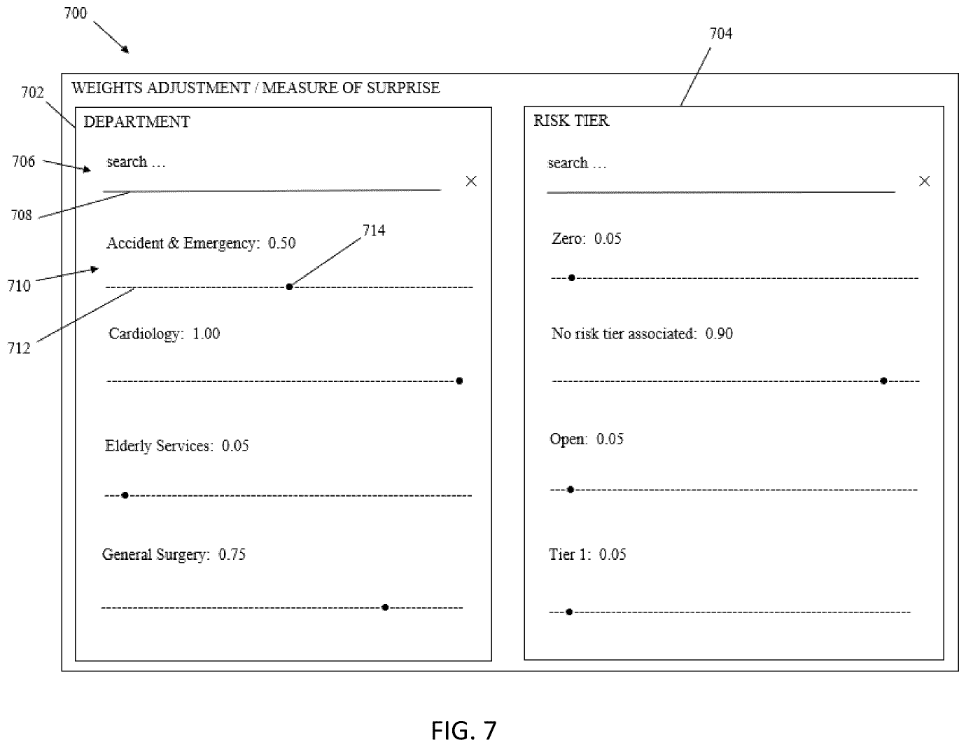

FIG. 7 is a screenshot of a GUI 700 configured to control settings of operating parameters of the forensic system 300. In one implementation consistent with the invention, the forensic system 300 is employed by a medical facility such as a hospital, with the forensic system 300 configured to perform anomaly detection in data 306 received from the plurality of entities 308 and to generate hospital alerts using z-scores, as described below. For example, the generated hospital alerts are output to a user, such as a reviewer, using the user interface 328 of the display 326, or using the input/output device 314, as described above. Anomaly detection analyzes or generates alerts to identify anomalous activity in the data 306, relative to peers in the peer groups 402, 404, 406. In one implementation, the anomalous activity indicates a higher risk, warranting further review or investigation of the data 306.

As shown in FIG. 7, in one implementation, the GUI 700 allows a user to manually adjust settings of operating parameters to adjust the calculation of a measure of surprise or the calculation of weights described above. The settings of the weights implement a weight rule applied to the processing of the data 306 and the metrics, as described above. In another implementation, other GUIs are configured and displayed allowing a user to manually adjust or tune other settings of operating parameters used in the forensic system 300. For example, the other GUIs include a GUI configured to set or adjust the reference period 602 and the observation period 604, a GUI configured to set or adjust data filters, a GUI to set or adjust thresholds, a GUI to make final adjustments, and a GUI to review the settings of the operating parameters of the forensic system 300.

In one implementation shown in FIG. 7, the weights are grouped into a department group 702 and a risk tier group 704. The GUI 700 includes a search region 706 including an input field 708 configured to receive user inputs to perform a search function implemented by the forensic system 300, in order to search for titles or indicators of weights, such as “Accident & Emergency”. For example, the department group 702 includes an accident and emergency weight 710, a cardiology weight, an elderly services weight, a general surgery weight, an intensive care unit (ICU) weight, an otolaryngology (car, nose, and throat) weight, a diagnostic imaging weight, a maternity weight, and an anesthetics weight. In another example, the risk tier group 704 includes a zero weight, a no risk tier associated weight, an open weight, a Tier 1 weight, a Tier 2 weight, a Tier 3 weight, a Tier 4 weight, and a data issue weight.

For each weight, such as the accident and emergency weight 710, a sliding scale 712 allows a user to click on and drag a button 714 or other graphical indicator to a position along the sliding scale 712 to set the value of the weight, such as the accident and emergency weight 710. In one implementation, the weight value of zero is at the leftmost position of the button 714 along the sliding scale 712, and the weight value of one is at the rightmost position of the button 714 along the sliding scale 712. As shown in FIG. 7, the weight values range from zero to one. For example, the weight value for the accident and emergency weight is set to 0.50, with the button 714 at the exact midpoint of the sliding scale 712. Optionally, the weight value is also displayed adjacent to the text identifying the accident and emergency weight. Similarly, the cardiology weight has a weight value of 1.00, while the elderly services weight value as well as the zero weight value, the open weight value, and the Tier 1 weight value in the risk tier group 704 is 0.05. In an alternative implementation, the sliding scale 712 has weight values in a range of percentages, such as between 0% or 100%. The weights are applied to every measure before any processing of the data 306 is performed. If a row of data matches more than one weight rule in the groups 702, 704, the row of data is multiplied by all of the matched weights.

The GUI 700 is displayed to a user, such as a system administrator using the input/output device 314. Using the GUI 700, the system administrator enters inputs setting the reference period 602, the observation period 604, filters, weight adjustments, and thresholds used by the forensic system 300. For example, using sliding scales and other known GUI-based actuatable icons and features, the system administrator adjusts risk levels configured to detect fictious orders, front running of trades, insider trading, and other types of anomalies in the data 306. The system administrator also adjusts risk tier levels and settings using the GUI 700. Accordingly, the system administrator is capable of changing parameters and behavior of the forensic system 302 on the fly.

Referring again to FIG. 6, the instance-based learning process 420 creates three different micro-statistical models 610 for each metric type in each peer group. A first micro-statistical model is generated for a metric distribution for all entities in the peer group. A second micro-statistical model is generated for each individual entity alone. A third micro-statistical model is generated showing the various metrics in each day. Every single micro-statistical model 610 is a data distribution defined by a mean and standard deviation. For example, with the three micro-statistical models 610, for twenty-five different metrics 408 and sixty peer groups 402, 402, 406, the instance-based learning process 420 creates up to 3×25×60=4,500 micro-models 610.

The forensic system 302 utilizes the measure of surprise multiplied by the metric count or other defined measures, such as market value change or blood pressure, to build the micro-statistical models 610. The instance-based learning process 420 builds models over peer groups, with each model built for every peer group over the Model's Attributes of Interest (MAoI). The MAoI is a set of shared attributes used to calculate and aggregate the scores over such attributes. The instance-based learning process 420 uses, for example, a simple Gaussian Distribution for performing the modeling to build such models on the fly and in real time, with the models involving a high volume of data, and with a relatively simple modeling and scoring process which is explainable to the reviewer of scores of the data 306.

To build a model, a weighted score for a metric M is determined from an initial score of the metric M times the measure of surprise of the metric M. An aggregated score (AggregatedScore-Reference) of the metric M for a given date is the sum of the weighted scores M for each date over the reference period. The score aggregation is performed over an MAoI set, and so for each combination of attributes in an MAoI set, a single aggregate value is determined per day. Once a set of scores in each peer group of entities 402, 404, 406 of entities 308 is determined, having a relatively large number of metrics in each set, a data distribution is treated as almost Gaussian or Normal. The peer group scores are then determined by the instance-based learning process 420 to be the aggregated scores for each metric Mi of all of the metrics over a date range from a start date to an end date. Such peer group scores have an almost normal distribution with a mean μ and a variance σ². For the available peer groups in a reference period and for the number of different combinations of MAoI, the number of created normal distributions with a mean u and a variance σ² can number in the hundreds or thousands.

The creation of these numerous micro-statistical models 610 requires a significant amount of computation power using known computational techniques such as vector processing. The forensic system 302 performs such vector processing on the fly and in real time based on user-defined criteria. In one implementation, the user-defined criteria is input by the input/output device 314 using the GUI 700 shown in FIG. 7. To operate with fast processing speed, the forensic system 302 uses known data processing techniques, such as database temporary tables stored in the memory 312 as matrices. Alternatively, the processor 310 includes specialized microprocessors fabricated to perform such fast processing to generate the micro-statistical models 610.

As described above, the instance-based learning process 420 applies the measure of surprise 608 to the micro-statistical models 610 to generate expected daily metric values 612 for each entity 308 according to the models 606. The scoring process 422 then performs, during the observation period 604, scoring of each metric from the expected daily metric values 612 to generate scores for each metric 408 using a predetermined scoring algorithm. In an implementation, the predetermined scoring algorithm computes a z-score for every metric against available micro-statistical models 610. In the above example, for forty active entities in an observation period 604, the scoring process 422 generates up to 40×25×4,500=4,500,000 calculated raw scores.

The scores are then normalized by the scoring process 422 over the observation period 604, and the score aggregation process 424 aggregates the scores over the plurality of entities 308 over the observation period 604. The aggregation of normalized scores are based on the MAoI scores. A system administrator, using the input/output device 314, sets which attributes to aggregate the normalized scores over. For example, if all metrics have attributes such as age, job-title, country, city, and salary-range, the MAoI can be set to aggregate just over the attributes of country, or over country, city, and salary-range. The settings of the attributes are stored in an attribute configuration file in the memory 312. The attribute configuration file can have a JSON file format, or any other known file format.

To detect anomalies, the scoring process 422 compares the available metrics over the observation period 604 to the models created for the reference period 602. To perform the comparison, an aggregated score (AggregatedScore-Observation) is determined using the observation period data such that the aggregated score (AggregatedScore-Observation) of the metric M for a given date is the sum of the weighted scores for each metric M for each date over the observation period, with the weighted scores for a metric M determined from an initial score of the metric M times the measure of surprise of the metric M. By considering the AggregatedScore-Observation for a metric Mi on a given date to be a sample of the aggregated score in one of the peer groups (PGs) that has a distribution model N_{PG}(μ_{PG}, σP_{G}²), the scoring process 422 determines a raw anomaly score (RawAnomalyScore) of a metric Mi in a peer group PG for a given day to be the absolute value of (AggregatedScore-Observation−μ_{PG})/σ_{PG}. The raw anomaly scores are determined for every metric in different peer groups over the available data in the observation period.

The normalization of scores is performed over all metric types and peer groups so that metric scores are comparable across the groups. For example, normalization generates normalized scores in the range from zero to one. Alternatively, other predetermined ranges of normalized scores are generated. Different peer groups have different data distributions, so for a next level of aggregation, the score aggregation process 424 scales the raw anomaly scores between zero and one such that the scaled score ScaledScore equals the ratio of the raw anomaly score (RawAnomalyScore) over (MaxScore+gamma), in which MaxScore is the maximum available score in each peer group, and gamma is a smoothing constant which makes the scaled scores relatively smooth and comparable across multiple peer groups. For example, gamma is set to the value one.

The scaled daily anomaly scores are determined for different combinations of each MAoI. The score aggregation process 424 performs a final aggregation of scores over metrics as well as individuals and entities. Accordingly, different metric scores are generated for each individual or entity 308, and the normalized and aggregated scores are displayed to visualize the results; for example, in the user interface 328 of the display 326. For example, when the score aggregation process 424 performs trader-level aggregation, a reviewer is presented with a single daily score per trader. The score aggregation process 424 determines a final score aggregation over any shared attributes. Alternatively, the score aggregation process 424 performs a final aggregation process over shared attributes between different MAoI sets. The default aggregation method used by the score aggregation process 424 is defined in a configuration file stored in the memory 312. Alternatively, using a GUI operating in conjunction with the input/output device 314, a system administrator selects a desired model from known or created models. Using the GUI, the system administrator also selects a desired aggregation method.

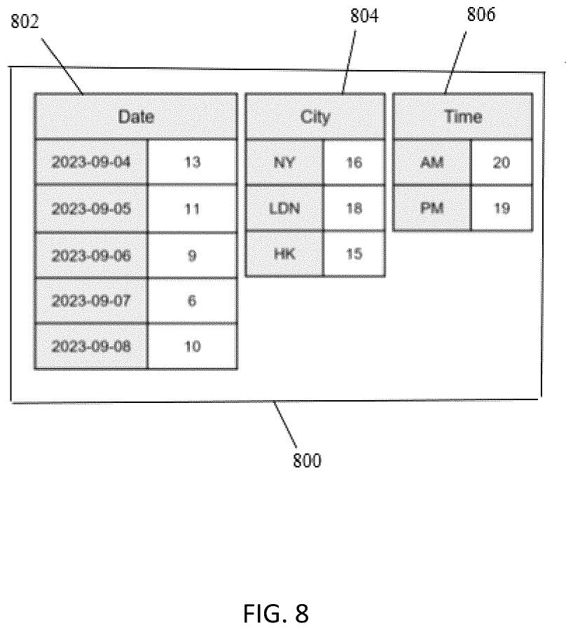

Referring to FIG. 4, the plurality of interfaces 416 includes a data forensic tool 426 and an anomaly detection and scoring query interface 428. The data forensic tool 426 includes a GUI allowing a data reviewer to view the metrics in a column-based visualization with data. For example, using a GUI-based control on the GUI, such as an actuatable icon or a drop-down menu selection, a column-based visualization 800 as shown in the screenshot in FIG. 8 has the generated scores sorted by dimension into columns 802, 804, 806. A dimension is defined to be a characteristic, feature, idea, or aspect associated with the data, such as a calendar date, a name, a time, etc. In one implementation, each characteristic, feature, idea, or aspect contributes to a scoring or a subject evaluation. Example dimensions for a computer-based device on a network include generated alarms associated with the device, a device type, a geolocation of the device, hour-of-day or time zone associated with the device, an operating system of the device, etc.

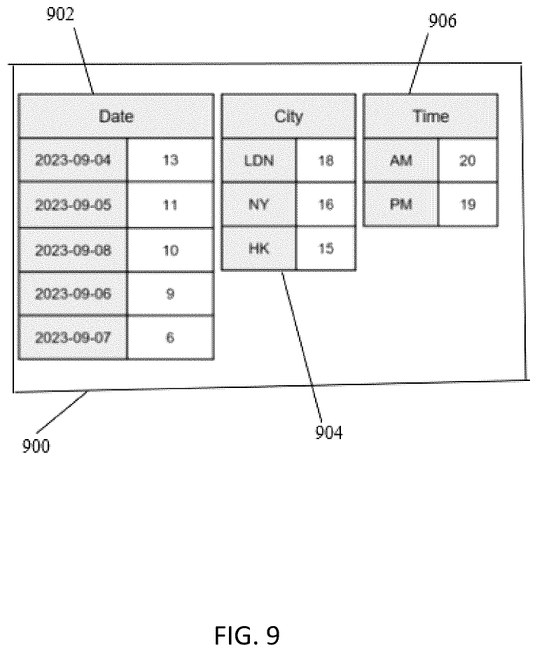

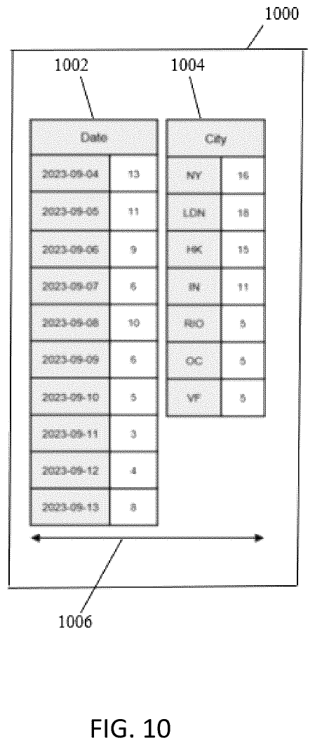

Using another GUI-based control on the GUI, such as an actuatable icon or a drop-down menu selection, a column-based visualization 900 as shown in the screenshot in FIG. 9 has the scores sorted by associated metric values into columns 902, 904, 907. Alternatively, the scores in the column-based visualization are sorted by date. In a further implementation, the scores in the column-based visualization are sorted by any known parameter. FIG. 10 is a further screenshot illustrating a column-based visualization 1000 with a fixed width per column for each of the columns 1002, 1004. Since the columns 1002, 1004 have a fixed width, the horizontal reviewing of all of the data in multiple columns 1002, 1004 by a reviewer is easily facilitated, as represented by the arrows 1006. The column-based visualizations 800, 900, 1000 in the GUI are implemented as a tool referred to as a “Dimension Slicer”, allowing a reviewer to selectively control and view the columns of data arranged by data, name, metric values, or any known parameter to facilitate the review of scores reflecting the data 306, making identification of problematic data by reviewers easier to spot. The Dimension Slicer tool is configured to visualize any SQL statement that returns a tabular dataset. The Dimension Slicer allows a user to also apply a filter, such as a recursive filter, over the data and to gradually narrow down the visualization to a desired portion of the displayed data.

In one implementation consistent with the invention, through such GUI-based controls on the GUI, such as an actuatable icon or a drop-down menu selection, a user sorts each column based on its dimension values or aggregated metric score, ascending or descending. In another implementation, sorting a column does not alter the sort order of other columns. Such a behavior is not possible in a row-based tabular data presentation known in the art. In a further implementation consistent with the invention, to change the sort order, a user operating a computer mouse simply clicks on an actuatable dimension name displayed on the GUI on the left or metric-name on the right side of the column header. In still another implementation, a default visualization is the column-based visualization of all dimensions, which reveals a comprehensive picture of the data. In a further implementation in addition to or separate from the column-based visualizations described above, a user operating the GUI selects to view the detail data as row-based tabular data as well.

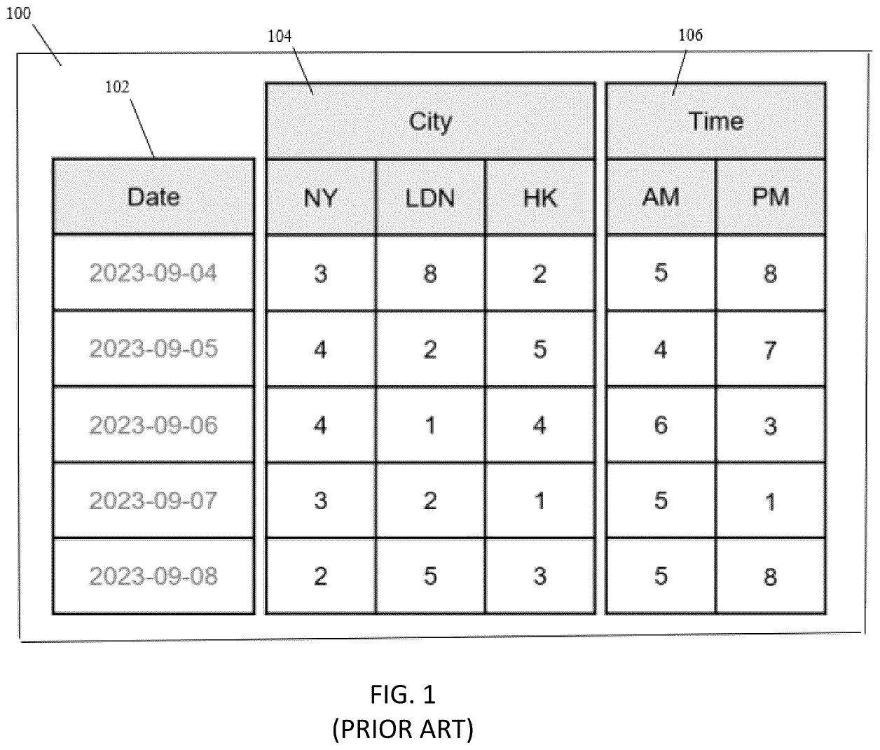

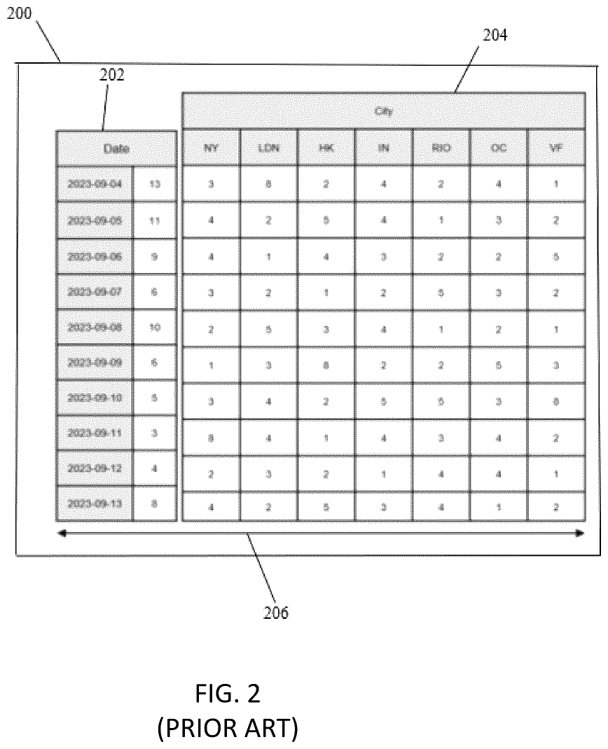

Such column-based visualizations 800, 900, 1000 in FIGS. 8-10, respectively, have advantages over the row-based visualizations 100, 200 in the prior art, as shown in FIGS. 1-2. In one advantage, for a selected criteria, such as five days of September, the reviewer of the column-based visualizations 800, 900, 1000 has access to a data distribution for all dimensions. In one look, the reviewer easily learns how differently dimensions are behaved. In another advantage, no dimension or column shown in the visualizations 800, 900, 1000 has any significance to the others. However, in row-based visualizations 100, 200, there is always a single row dimension, such as “Date”, which affects other dimensions. A third advantage of column-based visualizations 800, 900, 1000 provides sorting over all dimensions/columns which has a meaning, not just by date as the row-based visualizations 100, 200.

A fourth advantage of the column-based visualizations 800, 900, 1000 occurs when the dimensions or column cardinality are high. The reviewer scrolls just single column up and down which is easier than with the row-based visualizations 100, 200. For the row-based visualizations, the reviewer must scroll through entire visualization to the left and right. For collected data from twenty-five cities, then the reviewer of the row-based visualizations must scroll through 24×25=600 columns for dimension values. Accordingly, the row-based visualizations 100, 200 require wide, uncomfortable horizontal scrolling. On the contrary, using the column-based visualizations 800, 900, 1000, there is no difference between a column that has three entries and one with three hundred entries. In a fifth advantage, from a user experience point of view, when it comes to narrowing down the data, applying a filter is easier using the column-based visualizations 800, 900, 1000, allowing a reviewer to select the dimension values in a scrollable column and then apply the filter.

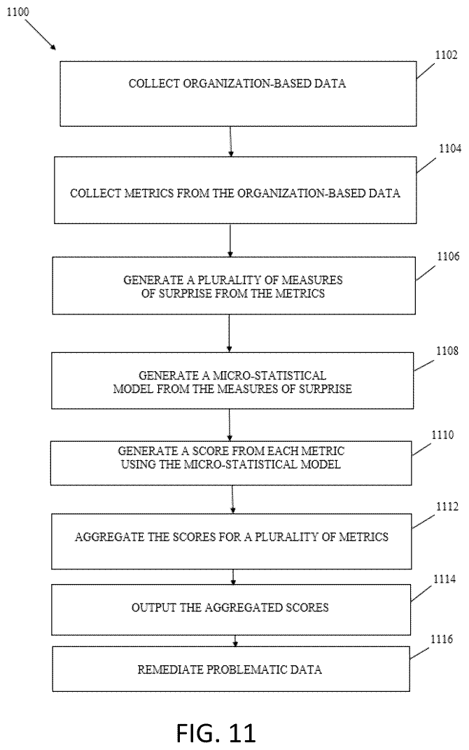

A method 1100 of remediation using the system 300 is shown in FIG. 11, includes the steps of collecting organization-based data 306 from a plurality of entities 308 in step 1102, collecting metrics 408 from the organization-based data 306 in step 1104, generating a plurality of measures of surprise from the metrics 408 in step 1106, generating a micro-statistical model from the measures of surprise in step 1108, generating a score from each metric using the micro-statistical model in step 1110, aggregating the scores for a plurality of metrics in step 1112, outputting the aggregated scores in step 1114, and remediating problematic data in step 1116.

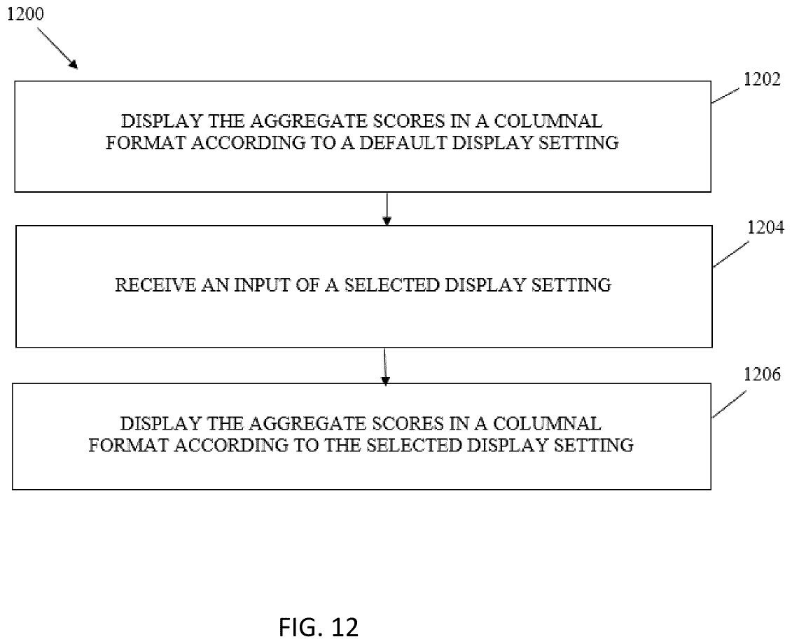

A method 1200 of visualization using the system 300 is shown in FIG. 12, including the steps of displaying the aggregate scores in a columnal format according to a default display setting in step 1202, receiving an input of a selected display setting in step 1204, and displaying the aggregate scores in a columnal format according to the selected display setting in step 1206.

The system 300 and methods 1100, 1200 are adapted to perform forensic analysis of electronic data using scoring. In one implementation consistent with the invention, such electronic data corresponds to financial trades in a financial organization. In an alternative implementation, the electronic data corresponds to medical data in a medical facility, such as a hospital. In a further implementation, the electronic data is any data involving an organization. Using the system 300 and methods 1100, 1200, a plurality of metrics such as KRIs are measured and scored across diverse groups and entities in an organization, such as a business unit (BU), a finance unit, and operation unit, allowing a review to detect, identify, and remediate problem data such as anomalies, outliers, and errors in transaction data such as electronic trades. With such fast processing, a reviewer can investigate and identify problematic data such as anomalies, outliers, and errors, and then create and implement a remediation of the problematic data within a short time, such as twenty-four hours, to be ahead of new inputs of trades for the next day. The system 300 and methods 1100, 1200 provide flexibility to be configured on the fly for a range of configurations, to be versatile for ad-hoc analytics from individual traders to groups or desks of traders. Accordingly, the system 300 and methods 1100, 1200 provide simplicity in the approach to triangulate on such anomalies, outliers, and errors. The system 300 and methods 1100, 1200 are extensible to any metrics or any number of metrics. Fungibility is also provided to operate across business space via multiple layers of process abstraction.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A system, comprising:
a hardware-based processor;
a memory configured to store instructions and configured to provide the instructions to the hardware-based processor; and
a set of modules configured to implement the instructions provided to the hardware-based processor, the set of modules including:
a metric collection module configured to collect a plurality of metrics measuring attributes of received data;
an analysis module configured to generate a measure of surprise (MOS) using a predetermined measuring algorithm applied to the metrics, wherein the measure of surprise is determined from:
$$MoS ( Mi , A ) = \frac{( 1 + \frac{1}{( 1 + {e}^{- k ( Δ H - 1 )} )} )}{MetricShareInReferencePeriod}$$
wherein ΔH is a change in an entropy of a respective metric Mi with reference to a respective attribute A from a reference period to an observation period, MetricShareInReferencePeriod is determined from counts of the metrics, and k is a predetermined scaling factor, and to generate a plurality of scores each associated with a corresponding metric using the measure of surprise;
a detection module configured to detect problematic data among the received data using the plurality of scores; and
a remediation module executes the instructions using the hardware-based processor and, responsive to user-defined criteria, remediates the problematic data including performing a remediation action selected from the group consisting of: a roll back of the problematic data, deletion of the problematic data, or flagging the problematic data, thereby correcting anomalies, outliers, or errors in the problematic data.

2. The system of claim 1, wherein the problematic data is selected from the group consisting of: an anomaly, an outlier, and an error.

3. (canceled)

4. The system of claim 1, wherein the received data include electronic financial trades.

5. The system of claim 1, wherein the analysis module normalizes the plurality of scores to be within a predetermined range of normalized values.

6. The system of claim 1, wherein the analysis module aggregates the plurality of scores to generate an aggregated score.

7. The system of claim 1, further comprising:
a display configured to display the plurality of scores associated with the received data.

8. The system of claim 7, wherein the display displays the plurality of scores in a column-based visualization sorted using a user-inputted visualization selection.

9. The system of claim 8, wherein the user-inputted visualization selection is selected from the group consisting of: sorting by dimension value, sorting by metric value, and sorting by date.

10. A system, comprising:
a display;
a hardware-based processor;
a memory configured to store instructions and configured to provide the instructions to the hardware-based processor; and
a set of modules configured to implement the instructions provided to the hardware-based processor, the set of modules including:
a metric collection module configured to collect a plurality of metrics measuring attributes of received data;
an analysis module configured to generate a measure of surprise (MoS) using a predetermined measuring algorithm applied to the metrics, wherein the measure of surprise is determined from:
$$MoS ( Mi , A ) = \frac{( 1 + \frac{1}{( 1 + {e}^{- k ( Δ H - 1 )} )} )}{MetricShareInReferencePeriod}$$
wherein ΔH is a change in an entropy or a respective metric Mi with reference to a respective attribute A from a reference period to an observation period, MetricShareInReferencePeriod is determined from counts of the metrics, and k is a predetermined scaling factor, and to generate a plurality of scores each associated with a corresponding metric using the measure of surprise;
a detection module configured to detect problematic data among the received data using the plurality of scores; and
a remediation module executes the instructions using the hardware-based processor and, responsive to user-defined criteria, remediates the problematic data including performing a remediation action selected from the group consisting of: a roll back of the problematic data, deletion of the problematic data, or flagging the problematic data, thereby correcting anomalies, outliers, or errors in the problematic data,
wherein the display displays the plurality of scores in a plurality of columns using a predetermined column-based visualization configuration.

11.-12. (canceled)

13. The system of claim 10, wherein the problematic data is selected from the group consisting of: an anomaly, an outlier, and an error.

14. The system of claim 10, wherein the received data include electronic financial trades.

15. The system of claim 10, wherein the analysis module normalizes the plurality of scores to be within a predetermined range of normalized values.

16. The system of claim 10, wherein the analysis module aggregates the plurality of scores to generate an aggregated score.

17. The system of claim 10, wherein the display displays the plurality of scores in a column-based visualization sorted according to a user-inputted visualization selection.

18. The system of claim 17, wherein the user-inputted visualization selection is selected from the group consisting of: sorting by dimension value, sorting by metric value, and sorting by date.

19. A computer-based method, comprising:
providing instructions to a hardware-based processor;
collecting received data in a database;
generating a plurality of metrics measuring attributes of the received data;
collecting a plurality of metrics of the received data in the database;
generating a plurality of measures of surprise (MOS) using a predetermined measuring algorithm wherein each measure of surprise is determined from:
$$MoS ( Mi , A ) = \frac{( 1 + \frac{1}{( 1 + {e}^{- k ( Δ H - 1 )} )} )}{MetricShareInReferencePeriod}$$
wherein ΔH is a change in an entropy of a respective metric Mi with reference to a respective attribute A from a reference period to an observation period, MetricShareInReferencePeriod is determined from counts of the metrics, and k is a predetermined scaling factor;
generating a micro-statistical model from the plurality of measures of surprise;
generating a plurality of scores, wherein each score corresponds to a respective one of the plurality of metrics using the micro-statistical model;
detecting problematic data among the received data using the plurality of scores;
outputting the plurality of scores, wherein at least one score indicates the problematic data;
receiving user-defined criteria; and
responsive to the user-defined criteria, executing the instructions using the hardware-based processor to remediate the problematic data including performing a remediation action selected from the group consisting of: a roll back of the problematic data, deletion of the problematic data, or flagging the problematic data, thereby correcting anomalies, outliers, or errors in the problematic data.

20. The computer-based method of claim 19, wherein the outputting includes:
receiving a user-inputted visualization selection; and
displaying the plurality of scores in a column-based visualization sorted according to the user-inputted visualization selection.
